(19) United States
(12) Patent Application Publication
(10) Pub. No.: US 2024/0167884 A1
(43) Pub. Date: May 23, 2024

(54) METHOD AND SENSOR FOR THE OPTICAL MEASUREMENT OF MEASURANDS OF TRANSPARENT MEDIA

(71) Applicant: Endress+Hauser Conducta GmbH+Co. KG, Gerlingen (DE)

(72) Inventor: Ralf Bernhard, Stuttgart (DE)

(21) Appl. No.: 18/515,688

(22) Filed: Nov. 21, 2023

(30) Foreign Application Priority Data
Nov. 21, 2022 (DE) 10 2022 130 665.8

(51) Int. Cl. G01J 5/53; G01J 3/28; G01J 5/80

(52) U.S. Cl. CPC G01J 5/53; G01J 3/2823; G01J 5/80; G01J 2005/0077

(57) ABSTRACT

Described is a method for measuring one or at least two measurands of a transparent medium, in which method pictures of a pattern are taken by means of a camera through a volume of predetermined shape of the medium, and measured values of the measurand(s) are determined and made available on the basis of effects of the volume of the medium on the pictures of the pattern, said effects being characteristic of the measurand(s) and dependent on the value thereof. Furthermore, a sensor is described which is designed to carry out this method.

### CROSS-REFERENCE TO RELATED APPLICATION

The present application is related to and claims the priority benefit of German Patent Application No. 10 2022 130 665.8, filed on Nov. 21, 2022, the entire contents of which are incorporated herein by reference.

### TECHNICAL FIELD

The present disclosure relates to a method for the optical measurement of one or at least two measurands of a transparent medium, and to a sensor for carrying out this method.

### BACKGROUND

Optical sensors are nowadays used in a variety of different applications for measuring measurands. Examples of optical sensors known from the prior art comprise turbidity sensors for measuring turbidity of the medium, sensors for measuring a concentration of particles contained in the medium, sensors for measuring a refractive index of the medium, and absorption sensors.

Optical sensors generally comprise a transmission device, which transmits electromagnetic transmission radiation to the medium, and a measuring device, such as a measuring device equipped with a detector, which receives measurement radiation resulting from an interaction of the transmission radiation with the medium, and determines and provides measured values of the respective measurand on the basis of the received measurement radiation.

Depending on the measurand, different measuring methods are generally used.

Thus, for measuring the turbidity and/or the concentration of the particles contained in the medium, for example, transmitted radiation can be transmitted into the medium and a measurement radiation, dependent on the respective measurand, of a measurement radiation scattered at predefined angles in the medium can be measured with corresponding positioned detectors.

The refractive index of a medium can be determined, for example, by determining the angle at which a total reflection of transmitted radiation transmitted to the medium occurs at the transition to the medium. Alternatively, the refractive index is determined, for example, by transmitting transmitted radiation through the medium and determining an angle by means of a detector, such as a line scan camera, in order to deflect the transmitted radiation at the transition to the medium.

With absorption measurements, transmitted radiation generated by means of the transmission device is transmitted through the medium, for example, and the measurand such as a spectral absorption coefficient of the medium or a concentration of an analyte contained in the medium, is determined based on the spectral intensity or the intensity spectrum of the measuring radiation emerging from the medium.

Due to the different measuring principles, multiple sensors are generally required for simultaneous determination of multiple different measurands of a medium.

In addition, a highly precise geometric arrangement of the individual sensor components is required in many optical sensors. This arrangement should be as stable and unchangeable as possible in order to avoid measurement errors caused by shifts of individual sensor components. Consequently, correspondingly small manufacturing tolerances are to be maintained during the production of these sensors, and a high degree of mechanical and thermal stability is to be ensured. Both are regularly associated with correspondingly high production costs.

### SUMMARY

It is an object of the present disclosure to provide a cost-effective method for optical measurement of measurands of transparent media, which method can be used in as versatile a manner as possible, and a sensor for optical measurement of measurands of transparent media, which sensor can be used in as versatile a manner as possible and can be produced cost-effectively. For this purpose, the present disclosure comprises a method for measuring one or at least two measurands of a transparent medium, in which pictures of a pattern are taken through a volume of predetermined shape of the medium using a camera, and measured values of the measurand(s) are determined and made available on the basis of effects of the volume of the medium on the pictures of the pattern, said effects being characteristic of the measurand(s) and dependent on the value thereof.

The present disclosure has the advantage that simple, cost-effective cameras can be used on the basis of the plurality of image points of the pictures that supply measurement information, and only low costs are associated with the production of the pattern. It is particularly advantageous that multiple measurands can be determined using a single sensor which can be produced cost-effectively and comprising the camera and the pattern on the basis of the pictures.

These sensors offer the advantage that the measurement accuracy that can be achieved thereby is significantly less sensitive to manufacturing tolerances and a misalignment of the spatial arrangement of individual sensor components occurring in the measuring operation, as is the case with conventional optical sensors, is avoided. This is due to the fact that a spatial assignment is given via the spatial arrangement of the images of individual pattern elements of the pattern contained in the pictures.

According to a first development, the method is such that the effects characteristic of the measurand(s) are quantitatively detected on the basis of the pictures and at least one reference picture of the pattern taken in each case through a volume of the predetermined shape of a reference medium having a known value of the or each measurand, and assigned to the associated measured value of the respective measurand, wherein the reference picture(s) comprise at least one experimentally generated and/or at least one reference picture produced numerically by simulation calculation. Additionally, or alternatively, measured values are determined on the basis of the pictures by means of a pattern recognition and/or classification method or a pattern recognition and/or classification method trained on the basis of training data. Additionally, or alternatively, at least one model for determining measured values of the measurand(s) is created in advance on the basis of training data, with the aid of which measured values are then determined, wherein: the measured values of the at least one of the or each measurand are determined in each case on the basis of the model or one of the models, in such a way that the dependence of the pictures reflects the respective measurand; and/or the measured values of the at least one of the or each measurand are determined in each case on the basis of the model or one of the models, in such a way that it takes into account the dependence of the pictures from the respective measurand and at least one further variable determinable by means of the pictures, wherein the at least one further variable comprises at least one further measurand, the measured values of which are determined and made available, and/or comprises at least one property of the medium that is different from each measurand to be measured and has an effect on the pictures.

Alternatively, according to a second development, the method is such that the measured values are determined by means of an analytical or numerical evaluation of the pictures, and/or values of at least one characteristic variable of the pictures dependent on the respective measurand are determined on the basis of the pictures for each measurand, and the measured values of the measurand(s) are determined on the basis of the values of the characteristic variables and in advance in a calibration method, the dependence of the values of the characteristic variable(s) representing calibration data on the values of the measurand(s) is determined.

For determining the measured values of at least one measurand which has an effect on the individual images of individual pattern elements of the pattern contained in the pictures, an approach is adopted such that each characteristic variable used for determining the measured values of the respective measurand is determined in each case on the basis of a plurality, an average value or a median of imaging characteristic variables of the individual images corresponding to the respective characteristic variable. Additionally, or alternatively, the measured values of each measurand are determined in each case on the basis of the values, determined on the basis of the pictures, of the characteristic variable(s) dependent on the respective measurand. Additionally, or alternatively, the measured values of the, at least one of the or each measurand are determined in each case in that: the values of the characteristic variable(s) dependent on the respective measurand are determined on the basis of the pictures; for at least one further variable that can be determined by means of the pictures, values of at least one characteristic variable of the pictures dependent on the respective further variable are determined, wherein the at least one further variable comprises at least one measurand different from the respective measurand and/or at least one property of the medium different from each measurand; the measured values of the respective measurand are calculated on the basis of the values of the characteristic variable(s) dependent on the respective measurand and the values, determined for each further variable, of the characteristic variable(s) dependent on the respective further variable by means of a calculation rule determined in advance on the basis of calibration data.

According to a third development, the method is such that the pictures are processed and the measured values are determined on the basis of the processed pictures and/or the pictures are processed in such a way that image shifts of the images of the pattern within the pictures are subsequently compensated, such as by a misalignment, by shifting individual sensor components of a sensor that comprises the camera and the pattern for generating the pictures and/or image shifts caused by vibrations, and/or pictures with a higher dynamic range that have been processed from multiple pictures taken with different exposure times are produced. Additionally, or alternatively, multiple pictures taken in chronological succession or the processed pictures produced therefrom are each combined into an overall image, such as combined by means of an image stacking method or an image processing method, and the measured values are determined using the overall images.

According to a fourth development, the volume is shaped in such a way that a volume width running parallel to the imaging path running through the volume varies at least in portions continuously or in stages in a direction perpendicular to the imaging path, and the measured values of the at least one or each measurand are determined in each case on the basis of the pictures, according to the first development and/or exclusively or at least primarily on the basis of those partial regions of the pictures in which the received radiation power is large enough to enable the determination of the measured values, and the value of the measurand has an effect on the pictures of the pattern elements to an extent that can be quantitatively measured by means of the evaluation device.

A fifth development provides that the volume has two or more volume regions of different shape, the individual volume regions are arranged in such a way that in each case a different pattern region of the pattern is taken by the camera through each volume region, and the pictures each comprise a number of picture regions corresponding to the number of volume regions, which in each case correspond to an image, taken with the camera through one of the volume regions, of the pattern region of the pattern arranged behind the respective volume region in the viewing direction of the camera, and the measured values of the at least one or each measurand, in each case: are determined on the basis of the pictures, according to the first development, and/or are determined exclusively or at least primarily on the basis of those picture regions which are suitable, well suited or best suited for this purpose due to the shape of the volume region through which these picture regions have been taken; and/or are determined in that the measured values of at least one measurand are determined on the basis of the images of a first pattern region of the pattern contained in the pictures, measured values of at least one further variable that can be determined on the basis of the pictures are determined in each case on the basis of the images, contained in the pictures, of at least one further pattern region of the pattern that are different from the first pattern region, and an approach is adopted such that the measured values of at least one further variable designed as one of the measurand(s) are made available, and/or a correction method is carried out in which the measured values of at least one measurand are each corrected on the basis of the measured values of at least one measurand different from the respective measurand and/or at least one further variable different from each measurand, in particular a property of the medium, and the corrected measured values of the respective measurand are made available.

A sixth development provides that: the measurand(s) comprise a turbidity of the medium, a concentration of particles contained in the medium, and/or an absorption coefficient of the medium; the measurand(s) comprise a refractive index of the medium, and/or a concentration of a substance contained in the medium and at least jointly responsible for the refractive index of the medium, wherein the volume used in the measurement of this (these) measurand(s) in the imaging path has an outer surface through which the imaging path runs and which is designed at least in portions such that radiation entering the volume of the medium and/or exiting from the volume through the respective outer surface is refracted in a manner dependent on the refractive index; measured values of at least one measurand designed as a secondary measurand are determined, the changes of which result in corresponding changes of at least one measurand measurable on the basis of the pictures; and/or measured values of at least one measurand are determined on the basis of the pictures of the pattern that are taken through the volume of the medium and a temperature of the medium measured using a temperature sensor.

Developments of the sixth development provide that: measured values of the turbidity and/or the concentration of the particles contained in the medium are determined on the basis of an image sharpness and/or a contrast of the pictures and/or of the pictures of the individual pattern elements of the pattern contained in the pictures, and/or on the basis of the size of the areas over which the pictures of the individual pattern elements of the pattern extend within the pictures; measured values of the refractive index and/or of the concentration of the substance are determined on the basis of a degree of a distortion of the pictures caused by the refractive index and the predetermined shape of the volume and/or at least one characteristic variable of the pictures changing depending on the degree of distortion, and/or measured values of the absorption are determined on the basis of a brightness of the image points of the pictures of the pattern.

Furthermore, the present disclosure comprises a sensor for measuring one or at least two measurands of a transparent medium, having a pattern, a camera for generating pictures of the pattern, wherein the camera and the pattern are arranged in such a way and the sensor is designed in such a way that an imaging path running from the pattern to the camera runs through a volume of predetermined shape of the medium inserted or insertable into the imaging path, and an evaluation device which is connected to the camera and which is designed to determine and make available measured values of the measurand(s) on the basis of effects of the volume of the medium on the pictures of the pattern, said effects being characteristic of the measurand(s) and dependent on the value thereof.

Developments of the sensor consist in that:
a) the measurand(s) comprise a turbidity of the medium, a concentration of particles contained in the medium, and/or an absorption coefficient of the medium,
b) the measurand(s) comprise a refractive index of the medium, and/or a concentration of a substance contained in the medium and at least jointly responsible for the refractive index of the medium, wherein the volume used in the imaging path has at least one outer surface through which the imaging path runs and which is designed at least in portions such that radiation entering the volume of the medium and/or exiting from the volume through the respective outer surface is refracted in a manner dependent on the refractive index,
c) the evaluation device is designed to determine measured values of at least one measurand designed as a secondary measurand, the changes of which result in corresponding changes at least of one measurand measurable on the basis of the pictures, and/or
d) the sensor comprises a temperature sensor for measuring the temperature of the medium, and the evaluation device is designed to determine measured values of at least one measurand on the basis of the pictures and a temperature of the medium measured with the temperature sensor.

A first development consists in that the sensor comprises a container, such as a container designed as a flow cell or as a disposable flow cell, which is transparent at least in portions and/or equipped with at least one transparent window, a container designed as a cuvette or as a disposable cuvette, or a container formed by a recess of the sensor open toward the surroundings, for receiving the medium, wherein the container has an interior which has the shape predetermined for the volume of the medium.

According to a development of the first development, a transparent window, a window designed as a planar pane, a window having the shape of a hollow-cylinder segment, a window having a prism-shaped region projecting into the container, a domed window, or a window having a window surface facing the interior of the container and curved into the container or out of the container is inserted into a first container wall of the container facing the camera or into the first container wall and into a second container wall of the container facing away from the camera and opposite the first container wall along the imaging path, and the imaging path runs through said window.

Developments of the last-mentioned development provide that:
a) one of the two windows is designed as a pane inclined with respect to the imaging path, and the other window is designed as a pane aligned perpendicular to the imaging path,
b) one of the two windows has a prism-shaped region projecting into the container, and the other window is designed as a pane or has a prism-shaped region protruding into the container, or
c) both windows are domed, both windows have a window surface which is curved into the container, or both windows have a window surface which faces the interior of the container and is curved out of the container.

Second developments of the sensor consist in that the volume having the predetermined shape, overall or at least in portions:
a) is designed as a cuboid or as a cube, is designed as a cylinder, which has the shape of a lens, a bi-convex lens, a plano-convex lens, a concave-convex lens, a convex-concave lens, a plano-concave lens or a bi-concave lens,
b) is shaped in such a way that a volume width running parallel to the imaging path running through the volume varies at least in portions continuously or in steps in a direction perpendicular to the imaging path, and/or
c) has two or more volume regions of different shape, wherein the individual volume regions are arranged in such a way that a different pattern region of the pattern is taken by the camera through each volume region.

According to a third development, the sensor comprises a lighting device for illuminating the pattern, which lighting device is designed to illuminate a front side of the pattern facing the camera and/or to illuminate the pattern from its rear side remote from the camera.

Developments of the third further development lie in that:
a) the lighting device comprises two or more radiation sources which can be switched on and off by means of a controller, or radiation sources designed as light-emitting diodes, which emit electromagnetic radiation of different wavelengths, and the evaluation device is designed to determine and make available the measured values of the measurand or at least one of the measurands in each case at two or more different wavelengths, wherein the evaluation device determines the measured values for each of the wavelengths in each case on the basis of those pictures which were taken during an illumination of or passing of light through the pattern with the radiation emitted by one of the radiation sources of the respective wavelength,
b) the lighting device comprises a broadband radiation source or a radiation source designed as an incandescent lamp, which is designed to output white light or light in a spectral range of 350 nm to 1200 nm, the camera is designed as a color camera, and the evaluation device is designed to determine the color of the medium on the basis of the color of pictures of the pattern generated during an illumination of or passing of light through the pattern with the white light and to make available a color measured value of the color and/or to detect and display color changes of the medium on the basis of the color,
c) the lighting device comprises a radiation source or a radiation source designed as a UV-LED, which radiation source is designed to output ultraviolet light with one or more excitation wavelengths located outside of the visual spectrum, the camera is designed to detect electromagnetic radiation in the visual spectrum, and the evaluation device is designed, on the basis of pictures of the pattern generated during an illumination of or passing of light through the pattern with the ultraviolet light:
c1) to determine whether or not the medium is a fluorescent medium and to make available corresponding information,
c2) to determine and make available intensity measured values of an intensity of a fluorescent light emitted by the medium, and/or
c3) to determine and make available concentration measured values of a concentration of a fluorescent component contained in the medium, and/or
d) the evaluation device is designed, on the basis of pictures of the pattern which are taken in chronological succession during a stroboscope illumination of or passing of light through the pattern carried out by means of the lighting device, to determine and make available measured values of a flow speed of the medium with which the medium flows through the container, and/or to output an alarm, and/or to output an alarm if the flow speed exceeds or falls below a predetermined limit value,
e) the lighting device comprises at least one radiation source designed as a broadband light source if the camera is designed as a color camera, as a camera with a color image sensor or as a WebCam, and the lighting device comprises at least one electromagnetic radiation of a radiation source emitting one or more wavelengths, such as at least one light-emitting diode or a laser, when the camera is designed as a black-and-white camera or as a camera with a monochromatic image sensor, and/or
f) the lighting device comprises two or more radiation sources, wherein the radiation sources comprise radiation sources arranged in a group, in an array and/or in an illumination ring.

According to a fourth development, the evaluation device is designed to identify images, contained in the pictures, of particles and/or bubbles which are contained in the medium and conceal the pattern, and to determine and make available measured values of at least one property of the particles and/or bubbles, such as their occurrence, their size, their number and/or their distribution.

A fifth further development consists in that:
the pattern a) has identical pattern elements arranged in a grid or randomly arranged and/or distributed in a planar plane, and/or is designed as a dot pattern, as a line pattern, as a grating or as a hole pattern, and/or b) is designed as a fixedly installed component or as an exchangeable component of the sensor, and/or
the pattern:
a) comprises printed-on, glued-on or applied pattern elements arranged on a support, on an inner side of a container wall of the container facing the camera or on or in a window inserted into the container, or
b) comprises a support designed as an opaque plate, on the side of which, facing the camera, there is arranged at least one pattern element printed on, glued on or applied, and/or through which there runs at least one recess, which forms one of the pattern elements, or
c) is designed as an electronically predeterminable pattern, wherein the pattern comprises a liquid crystal display for displaying the pattern elements or electronically controllable screens, such as screens controllable by means of liquid crystals, or
d) comprises a transparent support, on the rear side of which, facing away from the camera, first ends of light guides are fastened, the second ends of which are connected to a light source, wherein the pattern elements comprise light spots generated by light fed by means of the light source into the light guides, or
e) comprises a support with bores running through the support, wherein a first end of at least one light guide is inserted into the bores, wherein the second ends of the light guide are connected to a light source, and the pattern elements comprise light spots generated by light fed by means of the light source into the light guide, wherein the light guides have a light-conducting core having a diameter of a few micrometers and an outer diameter of greater than or equal to 100 μm or greater than or equal to 200 μm.

A sixth development consists in that: the camera comprises an image sensor, an optical system upstream of the image sensor, such as a lens or a telephoto lens, and/or a focusing device, the lighting device is arranged in the vicinity of the camera, and radiation emanating from the lighting device is arranged via a deflection device, such as a prism, onto which the rear side of the pattern remote from the camera is directed, a diffuser is arranged between the lighting device and the pattern, a collimator is arranged between the lighting device and the volume of the medium, and/or the camera and the evaluation device are arranged at a distance of greater than or equal to 10 cm or greater than or equal to 1 m from the volume of the medium.

According to a seventh development, the sensor comprises a reference volume of a reference medium which is designed as a component of the sensor or can be introduced into the sensor, wherein the reference volume is arranged in the sensor in such a way that the pictures taken by the camera comprise a measurement picture region, taken through the volume of the medium, of a pattern region of the pattern and a reference picture region, taken through the reference volume of the reference medium, of a further pattern region of the pattern.

Developments of the last-mentioned development provide that the reference volume of the reference medium is arranged next to the volume of the medium in the viewing direction of the camera, the reference medium is a solid or a liquid having a known value of the or each measurand, the reference volume has the shape predetermined for the volume, and/or the container of the sensor:
a) comprises a first interior for receiving the volume of the predetermined shape of the medium and a second interior adjacent thereto, which is separated from the first interior and is filled or can be filled with the reference volume of the reference medium, or
b) comprises a cuvette which has a first interior fillable or filled with the medium and is arranged on a base made of the reference medium which is designed as a solid and has the reference volume.

### BRIEF DESCRIPTION OF THE DRAWINGS

The present disclosure and its advantages will now be explained in detail using the figures in the drawing, which show several examples of embodiments. The same elements are indicated by the same reference numbers in the figures. In order to be able to represent components of, in part, different size, true-to-scale representation has been dispensed with.

FIG. 1 shows a sensor equipped with a flow-through cell;

FIG. 2 shows a pattern designed as a dot pattern;

FIG. 3 shows a pattern designed as a line pattern;

FIG. 4 shows a pattern designed as a hole pattern;

FIG. 5 shows a rear side of a pattern with pattern elements formed by light spots;

FIG. 6 shows a sensor equipped with a cuvette;

FIG. 7 shows a sensor having a deflection device inserted into an illumination path;

FIG. 8 shows a sensor designed as an immersion probe;

FIG. 9 shows a picture of a dot pattern taken through a turbidity-free medium and through a turbid medium;

FIG. 10 shows pictures of a dot pattern executed through media with different refractive indices;

FIG. 11 shows a picture of a line pattern;

FIG. 12 shows a sensor in the container of which at least one window having a prismatic region is used;

FIG. 13 shows a sensor in the container of which two domed windows are used;

FIG. 14 shows a sensor in which the volume, enclosed in the container, of the medium has two volume regions of different shape;

FIG. 15 shows a sensor with a reference volume of a reference medium;

FIG. 16 shows a container having an interior containing a reference medium; and

FIG. 17 shows a cuvette arranged on a base of a reference medium.

### DETAILED DESCRIPTION

The present disclosure relates to a method for measuring one or at least two measurands of a transparent medium 1, such as a refractive index n, a concentration Cp of particles contained in a liquid medium 1, and/or a turbidity T. In the method, pictures A of a pattern 5 are taken by means of a camera 3 through a volume V of predetermined shape of the medium 1, and measured values of the measurand(s) are determined and made available on the basis of effects of the volume V of the medium 1 on the pictures A of the pattern 5, said effects being characteristic of the measurand(s) and dependent on the value thereof.

In this case, for example, an approach is adopted such that the effects characteristic of the respective measurand are quantitatively detected on the basis of the pictures A and at least one reference picture of the pattern 5 taken by a volume of the predetermined shape of a reference medium and assigned to the associated measured value of the corresponding measurand. Media having a known value of the or each measurand are used as reference media. The reference pictures are preferably produced experimentally. Alternatively or additionally, however, at least one reference picture which is numerically generated, for example, by simulation calculations can optionally also be used.

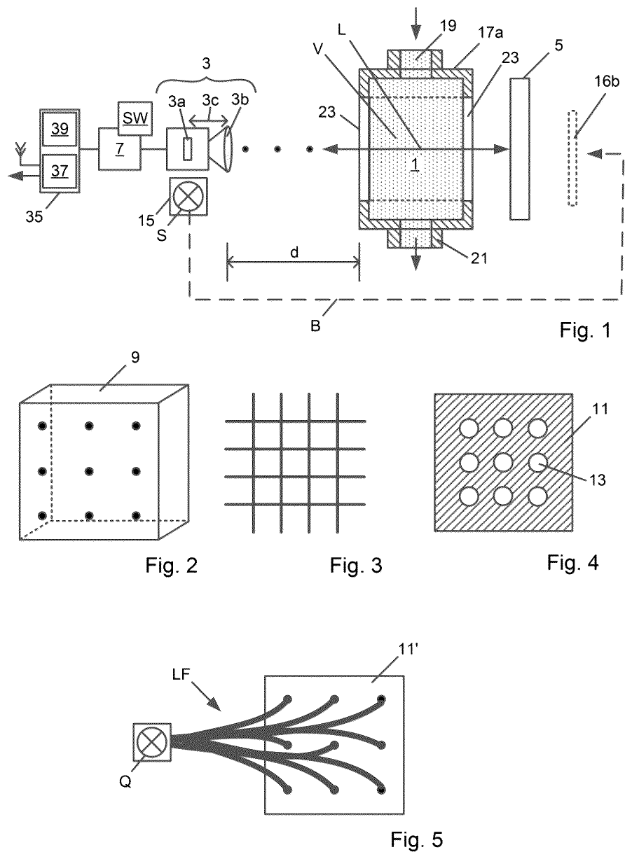

Furthermore, the present disclosure comprises a optical sensor comprising the pattern 5, the camera 3 and a evaluation device 7 connected to the camera 3 for measuring one or at least two measurands of a transparent medium 1, which is designed to carry out this method. An exemplary embodiment of this is shown in FIG. 1.

A pattern having pattern elements distributed over an area is suitable as a pattern 5. Well suited are patterns whose pattern elements are identical, the pattern elements of which are arranged in a grid and/or the pattern elements of which are all arranged in a planar pattern plane of the pattern. FIG. 2 shows as an example a pattern designed as a dot pattern, which comprises points arranged in a grid. FIG. 3 shows as a further example a pattern designed as a line pattern, which comprises lines forming a grating. Alternatively, however, other configurations, such as patterns with pattern elements of other shaping and/or with pattern elements arranged in another way relative to one another, can also be used. For example, instead of a proper arrangement of the pattern elements, a random arrangement of the individual pattern elements can be used. Alternatively or additionally, the pattern 5 can comprise, for example, pattern elements of different shapes.

Irrespective of their shape, the pattern elements are arranged, for example printed, glued, or applied in another way, for example, on a preferably planar front side of a support 9 facing the camera 3. If the support 9 consists of a transparent material, such as a glass, the pattern elements can alternatively also be arranged on a preferably planar rear side of the support 9 facing away from the camera 3, e.g. printed, glued or applied in another way or be arranged in the support 9. In patterns 5 whose pattern elements form a coherent mechanical structure, such as the grating shown in FIG. 3, a support is not absolutely necessary. A further alternative is that at least one of the pattern elements is designed as a recess 13 running through a support 11 designed as an opaque plate. FIG. 4 shows, as an example, a pattern of the pattern elements thereof, designed as a hole pattern, by recesses 13 which are circular in cross section and run through the support 11. Optionally, the pattern 5 can comprise, for example, a combination of pattern elements applied to the support 11 and designed as recesses 13.

A further embodiment consists in using pattern elements formed by light spots. In this case, the pattern 5 comprises a support 11′, such as the plate shown in FIG. 5, on which light guide LF fed via a light source Q connected thereto, such as a light-emitting diode, are fastened. A transparent support, on whose rear side remote from the camera 3 a first end of each light guide LF connected to the light source Q is fastened, is suitable as a support, for example. Alternatively, the support 11′ can have bores which run through the support 11′ and into which a first end of at least one of the light guides LF is inserted. For example, light guides whose light-conducting core has a diameter of a few micrometers are suitable as light guides LF. This offers the advantage that light spots with a corresponding small diameter can thereby be produced. At the same time, the light guides LF preferably have an outer diameter of greater than or equal to 100 μm or greater than or equal to 200 μm. This offers the advantage that the bores whose inner diameter corresponds to the outer diameter of the light guides LF can be produced in a simple and cost-effective manner.

Irrespective of the embodiments described above, the pattern 5 is designed, for example, as a fixedly installed component of the sensor. Alternatively, the pattern 5 is designed as an exchangeable component, for example. The latter offers the advantage that different patterns 5 can be used for different applications.

Alternatively, however, this advantage can also be achieved by using an electronically predeterminable pattern as pattern 5. In this case, the pattern 5 comprises, for example, a liquid crystal display by means of which the pattern elements are displayed, or electronically controllable screens, such as screens controllable by means of liquid crystals.

The camera 3 is preferably designed as a digital camera. A simple, cost-effective camera 3 with an image sensor 3a, such as a camera chip, and an optical unit 3b upstream of the image sensor 3a, such as a simple, cost-effective lens, is suitable for this purpose, for example. Alternatively, however, the optics 3 can also comprise optical systems known and/or more complex from photograph, such as a telephoto lens, for example. A telephoto lens is advantageous when the camera 3 is arranged at a greater distance from the pattern 5. Depending on the embodiment of the sensor and/or the camera 3, the camera 3 can comprise, for example, a focusing device 3c. A device shown schematically in FIG. 1 by a double arrow is suitable for this purpose, by means of which device the position of the image sensor 3a and/or of the optics 3b along an optical axis of the camera 3 can be set. Alternatively, however, more complex focusing devices known from the photograph, such as an autofocus, can also be used, for example. In both cases, for example, a central region of the pattern 5 is focused.

Irrespective of the embodiment in this regard, the camera 3 is designed, for example, as a black white camera, for example as a black white camera with a monochrome image sensor, or as a color camera, for example as a color camera with a color image sensor or as a WebCam, which detects electromagnetic radiation in the visual spectrum and/or in the near-infrared region. A camera 3 with low resolution, such as a resolution of 1 to 10 megapixels, can be readily used. Corresponding cameras are nowadays obtainable very cost-effectively. Radiation detection in the near-infrared region is advantageous when the medium 1 has a strongly pronounced coloring.

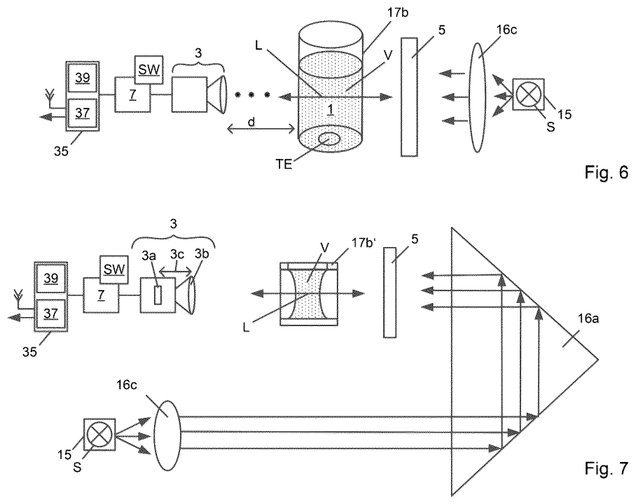

Optionally and/or if required, a lighting device 15 can be provided for illuminating the pattern 5. FIG. 1 shows, as an example, a lighting device 15 by means of which a front side of the pattern 5 facing the camera 3 can be illuminated. In this case, the lighting device 15, as shown in FIG. 1, is arranged, for example, in the vicinity of the camera 5 or integrated in the camera 5. In conjunction with patterns 5 with non-transparent pattern elements arranged on a transparent support 9, in conjunction with pattern elements designed as recesses 13, and also in connection-free patterns, such as patterns whose pattern elements form a coherent mechanical structure, such as a grid, the pattern 5 can alternatively have light passed through it from its rear side remote from the camera 3. In this case, the rear side of the pattern 5 remote from the camera 3 is illuminated by means of the lighting device 15. This is illustrated in FIG. 1 by the illumination path B which runs from the lighting device 15 to the rear side of the pattern 5 and is shown as an alternative by a dashed arrow. FIG. 6 shows a sensor constructed analogously to the sensor shown in FIG. 1, in which sensor the lighting device 15 is arranged on the side of the pattern 5 remote from the camera 3.

Irrespective of whether the pattern 5 is illuminated at the front or has light passed through it from the rear side, the radiation generated by the lighting device 15 is transmitted in the direction of the pattern 5 either directly or alternatively via at least one optical and/or beam-guiding element inserted into the illumination path B, such as a waveguide and/or a mirror, depending on the position of the lighting device 15 in the sensor. FIG. 7 shows a schematic diagram of a sensor constructed analogously to the sensor shown in FIG. 1, in which sensor the lighting device 15 is arranged in the vicinity of the camera 3, and the radiation emanating from the lighting device 15 is directed via a deflection device 16a, such as a prism, onto the rear side of the pattern 5 remote from the camera 3. FIG. 1 shows as a further example a diffuser 16b arranged in the illumination path B between the lighting device 15 and the pattern 5 and shown in dashed lines in FIG. 1. The diffuser 16b offers the advantage that a more uniform illumination of the pattern 5 can thereby be achieved. FIGS. 6 and 7 each show, as a further example, a collimator 16c arranged between the lighting device 15 and the volume V of the medium 1, such as a lens or a thick pinhole diaphragm. Collimators 16c offer the advantage that they bring about an approximately parallel beam path of the beams entering the volume V. Alternatively, a parallelization of the beams can also be effected by a correspondingly large distance between the lighting device 15 and the volume V of the medium 1, or a parallelization of the beam path can be omitted entirely.

A device which comprises at least one radiation source S, which generates electromagnetic radiation, is suitable as the lighting device 15, for example. A broadband light source, such as an incandescent lamp or a radiation source, which outputs white light or light in a spectral range of 350 nm to 1200 nm, is suitable as a radiation source S in conjunction with a camera 3 designed as a color camera. A narrowband illumination is preferably used in conjunction with a camera 3 designed as a black white camera. In this case, sources, such as a Laser or light-emitting diodes, which in each case emit radiation of one or more wavelengths are suitable as radiation sources S. Radiation sources S designed as lasers offer the advantage that they enable a greater distance between the radiation source S and the pattern 5 to be illuminated. In lighting devices 15 having two or more radiation sources S, different arrangements of the individual radiation sources S can be used. The radiation sources S can comprise, for example, in a group, radiation sources S arranged in an Array and/or in an illumination ring.

The sensor is designed to take pictures A of the pattern 5 through the volume V of predetermined shape of the medium 1 by means of the camera 3 and to provide the evaluation device 7. For this purpose, the camera 3 and the pattern 5 are arranged in such a way that an optical imaging path L running from the pattern 5 to the camera 3 runs through the volume V of the medium 1 used or usable in the imaging path L. In the example shown in FIG. 1, the volume V of the medium 1 is arranged for this purpose in the viewing direction of the camera 3 between the camera 3 and the pattern 5.

The insertion of the volume V of the medium 1 into the imaging path L can be effected in different ways. In conjunction with media 1 designed as solid bodies, it is, for example, moved in such a way that the solid body having the predetermined shape is correspondingly positioned. In conjunction with media 1 present as a liquid, as shown in FIGS. 1 and 6, it is preferably moved in such a way that the medium 1 is introduced into a correspondingly positioned or positionable containers 17a, 17b, which at least in portions are transparent and/or equipped with at least one transparent window, for receiving the medium 1. The container 17a, 17b has an interior filled or fillable with the medium 1 and has the shape specified for the volume V of the medium 1. For this purpose, the container 17a, 17b and/or each window has, for example, a shaping in each case which causes the volume V used or usable in the imaging path L in the container 17a, 17b to assume the shape specified for the volume V of the medium 1. The container 17a, 17b can be designed, for example, as an integral component of the sensor or as a separate element insertable into the imaging path L.

The container 17a shown as an example in FIG. 1 is designed as a flow-through cell through which the medium 1 can flow. The flow cell shown comprises an inlet 19, to which a supply line can be connected, via which supply line the medium 1 can be supplied to the flow cell, and an outlet 21, to which a discharge line can be connected, via which discharge line the medium 1 can be discharged from the flow cell. FIG. 1 is a transparent window 23 inserted into a first container wall of the container 17a facing the camera 3 and a second container wall of the container 17a opposite the first container wall along the imaging path L and facing away from the camera 3. Correspondingly, the volume V of the medium 1 through which the imaging path L runs and through which the pictures A are taken is arranged here between the two windows 23. Alternatively, however, the flow measuring cell can also consist at least in portions of a transparent material, such as a glass or a transparent plastic.

The container 17b shown in FIG. 6 is designed as a cuvette into which a sample of the medium 1 can be filled. A cuvette made of a transparent material, such as a glass cuvette, for example, is suitable for this purpose. Alternatively, the cuvette can consist of a non-transparent material. In this case, a transparent window is each inserted into at least one container wall of the cuvette through which the imaging path L runs. Different shapes of the volume V can be specified via the shape of one-piece cuvettes or the shape of the windows inserted into the cuvette. Thus, the volume V enclosed in the cuvette shown in FIG. 6 has the shape of a solid cylinder. FIG. 7 shows, as a further example, a volume V which is also arranged in the interior by a correspondingly shaped container 17b′, such as formed by one piece cuvette, and which has the shape of a bi-concave lens.

For example, disposable cuvettes, which are disposed of after their use, are suitable as cuvette. This is advantageous in applications where special requirements apply to Hygiene and/or contamination of the medium 1 that can be introduced into the cuvette is to be avoided.

Analogously, the container 17a shown as a flow cell shown in FIG. 1 can also be designed as a disposable flow measuring cell.

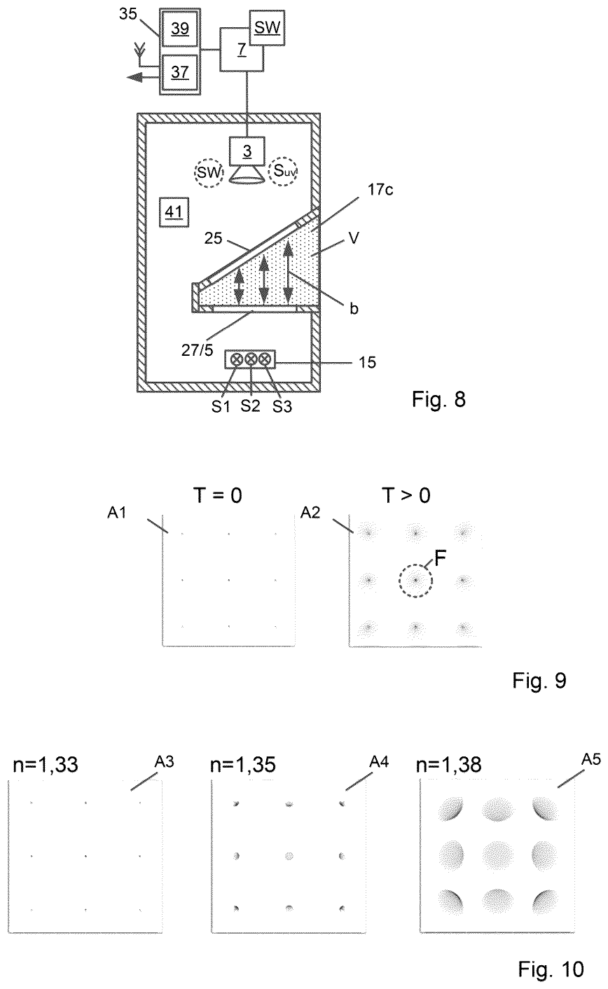

FIG. 8 shows a further modification of the sensor shown in FIG. 1. The sensor shown in FIG. 8 is designed as an immersion probe whose container 17c is formed by a recess of the sensor which is open toward the surroundings and which automatically fills with the volume V of the medium 1 specified by the shape of the recess when the section of the sensor comprising the recess is immersed into the medium 1. Analogous to the container 17a shown in FIG. 1, in the container 17c formed by the recess in FIG. 8, a transparent window 25, 27, through which the imaging path L runs, is inserted, for example, in each case into a transparent window 25, 27 through which the imaging path L runs.

The evaluation device 7 connected to the camera 3 is designed to determine and provide the measured values of the or each measurand on the basis of the pictures A of the pattern 5. For this purpose, the evaluation device 7 comprises, for example, a computer, a processor, and/or a computing device, for executing a computer program SW installed on the evaluation device 7 for determining the measured values.

When determining the measured values, use is made of the fact that the volume V of the medium 1 with respect to the pictures A acts like an optical element inserted into the imaging path L, the imaging characteristic of which, dependent on the optical properties of the medium 1 and the predetermined shape of the volume V, reflects deviations of the pictures A of the pattern 5 from the pattern 5 corresponding to the imaging characteristic. Accordingly, measured values of measured values, the changes of which lead to corresponding changes of the imaging characteristic, can be determined using the pictures A. The measurand-dependent imaging characteristic causes, for the measurand(s), the effects of the volume V of the medium on the pictures A of the pattern 5 that are characteristic of the value of the measurand(s). Accordingly, the measured values of the measurand(s) are determined and made available by means of the correspondingly designed evaluation device 7 on the basis of effects of the volume V of the medium on the pictures A of the pattern 5, which effects are characteristic of the value of the measurand(s).

FIG. 9 shows, as an example, two pictures A1, A2 of the dot pattern shown in FIG. 2, which pictures are taken with the camera 3 by means of a volume V of the medium 1 shown in FIG. 7 and have a bi-concave lens, wherein the medium 1, in the case of the picture A1 shown on the left, was unturbid and had been subjected to the picture A2 shown on the right. The turbidity T of the medium 1 is caused by particles contained in the medium 1, at which at least a portion of the electromagnetic radiation propagating parallel to the imaging path L through the volume V of the medium 1 is scattered. As can be seen from FIG. 9, this effect results in the stronger the medium 1 being subjected to image sharpness and contrast of the images of the individual pattern elements contained in the pictures A. At the same time, the scattering results in the greater the stronger the medium 1, the greater the areas F over which the images of the individual pattern elements extend within the pictures A. This is shown in FIG. 9 by way of example using the example of the encircled area F of one of the images of the dot-like pattern elements contained in the picture A2.

Both the effect that image sharpness and contrast of the images of the individual pattern elements changes as a function of the degree of turbidity T of the medium 1, and the effect that the areas F of the images change as a function of the degree of turbidity T of the medium 1, occurs in any desired shapes of the volume V, so that, with regard to the measurement of the measurand, turbidity T does not have to be observed with respect to the shape of the volume V. The measurand of turbidity T can thus also be measured, for example, if the volume V of the medium 1 used in the imaging path L is designed as a cuboid or cube. In the example shown in FIG. 1, this volume shape can be achieved, for example, by the two windows 23 being designed as planar panes running parallel to one another and perpendicular to the imaging path L.

Analogous to the turbidity T of the medium 1, the concentration Cp causing the turbidity T of particles contained in the medium 1 naturally also acts on the pictures A of the pattern 5. Accordingly, this concentration Cp likewise forms one of the measurand measurable or measured using the method described here and/or the sensor.

Under the precondition that the volume V of the medium 1 has at least one outer surface through which the imaging path L runs and which is designed at least in portions such that radiation entering through the corresponding outer surface into the volume V of the medium 1 and/or exiting from the volume V is refracted in a manner dependent on the refractive index n, the refractive index n of the medium 1 also leads to deviations of the pictures A from the taken pattern 5 that are dependent on the value of the refractive index n and characteristic of the refractive index n. Such a shape of the volume V, referred to below as a refractive shape, can be achieved, for example, by the volume V having at least one outer surface through which the imaging path L runs and which runs at least in portions at an angle different from 90°, such as at an acute or obtuse angle, to the portion of the imaging path L running through the volume V. For this purpose, the corresponding outer surface can be curved, bent, and/or inclined relative to the imaging path L, for example at least in portions.

FIG. 10 shows, as an example for this, three pictures A3, A4, A5 generated numerically by simulation calculations, which pictures correspond to the camera 3 through pictures of the dot pattern shown in FIG. 2, which volume has a refractive shape, wherein the medium 1 in the picture A3 shown on the left has a refractive index n of 1.33, in the middle picture A4 a refractive index n of 1.35, and with the picture A5 shown on the right a refractive index n of 1.38, and wherein the volume V had the shape shown in FIG. 7 of a bi-concave lens. As can be seen from FIG. 10, the refractive index n of the medium 1 leads to a distortion of the pictures A of the pattern 5 dependent on its value, wherein the degree of distortion increases with increasing refractive index n. At the same time, the deflection, which experiences electromagnetic radiation when entering the volume V and/or when exiting the volume V of the medium 1, results in the areas over which the images of the individual pattern elements extend within the pictures A change in a manner dependent on the shape of the volume V, the position of the corresponding pattern element within the pattern 5 and the refractive index n of the medium 1.

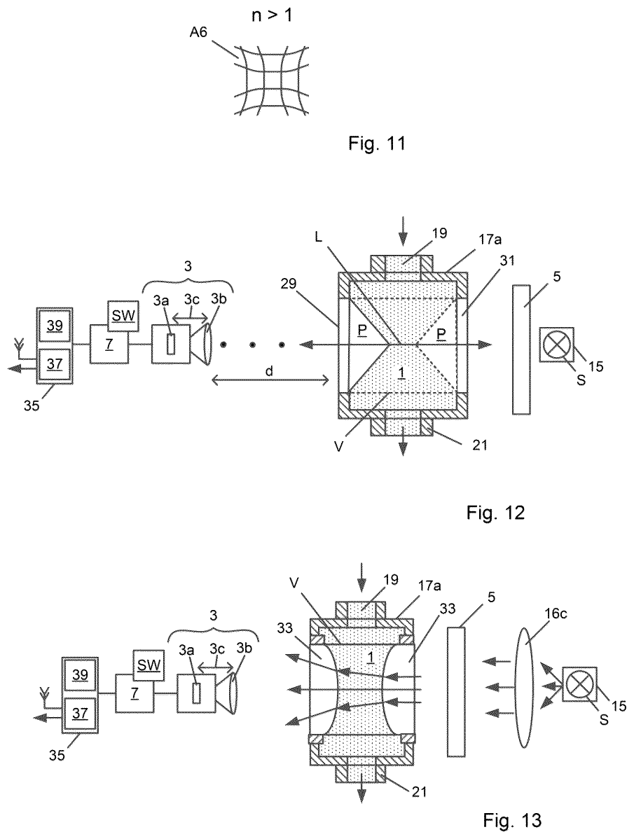

FIG. 11 shows, as a further example, a picture A6 of the line pattern shown in FIG. 3, which picture was taken with the camera 3 through a volume V, having a refractive shape, of the medium 1 having a refractive index n of greater than 1. Here too, the refractive index n of the medium 1 leads to a distortion of the pictures A of the pattern 5 dependent on its value. As can be seen from FIG. 11, the deflection which experiences electromagnetic radiation during passage through the volume V of the medium 1, at line patterns, results in a curvature of the images of straight lines contained in the pictures A, which curvature is dependent on the refractive index n, and with an increase in the line width of the images of the lines dependent on the refractive index n. Furthermore, the surfaces over which the images of the grid surfaces of the pattern 5 enclosed between the lines are in a manner dependent on the shape of the volume V, the position of the corresponding grid surface within the pattern 5 and the refractive index n of the medium 1 change.

The refractive shape of the volume V required for the measurement of the refractive index n is caused, for example, by a corresponding shape of the solid body in the case of media 1 designed as solid bodies. In the case of media 1 designed as a liquid, it is, for example, brought about by a corresponding shape of the interior of the container 17a, 17b, 17b′, 17c receiving the volume V.

An embodiment enabling the measurement of the refractive index n is that the volume V has the shape of a solid cylinder. In the sensor shown in FIG. 6, this volume shape can be achieved in that the container 17b designed as a cuvette comprises a hollow cylindrical container wall surrounding the volume of the medium 1 on all sides on all sides. Analogously, this volume shape in the sensor shown in FIG. 1 can be achieved, for example, by the container 17a and/or the windows 23 being designed such that the volume V of the medium 1 located in the container 17a, through which the imaging path L runs, is cylindrical. If the container 17a is made of an untransparent material, the windows 23 shown in FIG. 1 can, for example, be hollow cylinder segment-shaped or can be designed as components of a transparent hollow cylinder surrounding the volume V of the medium 1 on the outside side.

A further embodiment consists in that the volume V has at least one planar outer surface through which the imaging path L runs and which runs at an angle different from 90°, such as an acute or obtuse angle, to the portion of the imaging path L running through the volume V. In the example shown in FIG. 8, the planar outer surface of the volume V that is inclined relative to the imaging path L is achieved in that at least one window delimiting the volume V, such as the window 25 shown in FIG. 8, is designed as a planar pane inclined relative to the imaging path L. In this case, a surface normal runs on the pane at an acute or an obtuse angle to the imaging path L. In FIG. 8, the second window 27 is designed as a planar pane running perpendicular to the optical imaging path L. Alternatively, however, the second window 27 can also have a different shape and/or orientation.

FIG. 12 shows, as a further embodiment, a modification of the sensor shown in FIG. 1, in which a window 29 is inserted into the container 17a, which window comprises a prism-shaped region P projecting into the container 17a. Optionally, the second window 31 shown in FIG. 12 can also comprise a prism-shaped region P which projects into the container interior and is shown in dashed lines in FIG. 12. Alternatively, however, the second window 31 can also be designed as a planar pane.

Another embodiment enabling the measurement of the refractive index n is that the volume V used in the imaging path L has the shape of a lens, such as a bi-convex, a plano-convex, a concave-convex, a convex-concave, a plano-concave or a bi-concave lens. For this purpose, the volume Vis designed, for example, in such a way that at least one outer surface of the volume V through which the imaging path L runs is curved. A spherically curved outer surface is suitable as a curved outer surface. Corresponding volume shapes can be achieved, for example, in that at least one window is inserted into the containers 17a, 17b, 17c, the window surface of which window facing the interior is curved in the container 17a, 17b, 17c or out of the container 17a, 17b, 17c in accordance with the desired lens shape.

FIG. 13 shows as an example a modification of the sensor shown in FIG. 1 in which the volume V has the shape of a bi-concave lens. For this purpose, the volume V enclosed in the container 17a and inserted into the imaging path L is arranged between two, for example domed, windows 33 inserted into the container 17a. The bi-concave shape offers the advantage that it leads to a distortion of the pictures A that is dependent on the refractive index n and symmetrical to a center. This effect is illustrated in FIG. 13 by means of electromagnetic beams shown by arrows in the example of the volume V, which acts on entry into and on exit from the lens-shaped, due to the refractive index n of the medium 1, here as a dissipation lens. The shown effect of the bi-concave shape of the volume V as a diverging lens occurs when the refractive index n of the medium 1 is greater than the refractive index of the windows 33. The greater the refractive index n of the medium 1, all the more pronounced. The bi-concave shape can also be used analogously if the refractive index n of the medium 1 is smaller than the refractive index of the windows 33. In this case, the volume V having the bi-concave shape acts as a converging lens, wherein the collecting effect is the more pronounced the smaller the refractive index n of the medium 1 is. The advantage of a symmetrical distortion occurring in both cases can also be achieved analogously by an at least sectionally bi-convex shape of the volume V.

The volume shapes described above using the example of the volume shapes described in FIGS. 8, 12, and 13 are achievable not only with flow cells, but analogously also with other container types with correspondingly shaped interior for receiving the volume V. In containers designed as cuvettes, these volume shapes can be achieved by a corresponding shaping of the cuvette wall surrounding the volume V. This is shown in FIG. 7 using the example of the container 17b′ designed there as a cuvette with a container 17b′ having the shape of a bi-concave lens.

As an alternative or in addition to the measurands turbidity T and/or refractive index n, measurands that act in a manner characteristic of the corresponding measurand on the pictures A of the pattern 5 can be determined using the method and/or the sensor. An example of this is an absorption coefficient a of the medium 1, which results in the more electromagnetic radiation being absorbed in the medium 1, the lower the brightness of the image points of the pictures A is the lower.

Alternatively or additionally, for example, measured values of at least one measurand designed as a secondary measurand are determined, the changes of which result in corresponding changes of at least one measurand measurable on the basis of the pictures A. These include, for example, a particle concentration Cp of particles contained in the medium 1 that causes the turbidity T of the medium 1, and a concentration Cz of a substance contained in the medium 1, at least responsible for the refractive index n of the medium 1, such as a concentration of sugar contained in water.

The measured values are determined by means of the evaluation device 7 connected to the camera 3, which is designed to determine and provide the measured values of the corresponding measurand for the or each measurand on the basis of the pictures A of the pattern 5. With regard to the determination of the measured values, it can be moved in different ways. The measured values can thus be determined, for example, by means of an analytical or numerical evaluation of the pictures A and/or by means of a pattern recognition and/or classification method, such as a pattern recognition and/or classification method trained on the basis of training data, and/or determined.

Thus, when using a pattern recognition method and/or a classification method, for example, it is moved in such a way that, on the basis of training data, at least one model for determining measured values of the measurand(s) is created in advance on the basis of the following measured values. For this purpose, reference pictures of the pattern 5 generated through the volume V of the predetermined shape of reference media with different known values of the or each measurand are used as training data. For example, methods used nowadays in image recognition and/or for training classifiers, such as neural networks, machine learning methods and/or methods based on artificial intelligence, can be used for model creation. In this case, the model or each model used for determining the measured values of the measurand or at least one of the measurands is respectively created in such a way that it represents the dependence of the pictures A on the corresponding measurand.

In principle, the determination of the measured values of the at least one of the or each measurand can in each case take place on the basis of a model determined for the corresponding measurand, which model only reflects the dependence of the pictures A on this measurand. Alternatively, the measured values of the at least one of the or each measurand are determined in each case on the basis of a model which is created in such a way that it takes into account the dependence of the pictures A on the corresponding measurand and at least one further variable determinable by means of the pictures A. The at least one further variable comprises, for example, at least one further measurand, the measured values of which are determined and made available with the sensor and/or method. This offers the advantage that the sensor can be used as a multiparameter sensor for measuring two or more different measurands. Alternatively or additionally, the at least one further variable comprises, for example, at least one property of the medium 1 that is different from the measurands to be measured and effects on the pictures A. In this case, the training data comprises the volume V of the predetermined shape of reference media with different, known values of the or each measurand and each reference picture of the pattern 5 generated through the measurands. Models that take into account the effects of two or more measurands and/or at least one variable different from each measurand on the pictures A offer the advantage that the measurement accuracy of the measured values of the individual measurands is thereby increased.

In the analytical or numerical evaluation, for example, it is moved in such a way that values of at least one characteristic variable of the pictures A dependent on the corresponding measurand are determined on the basis of the pictures A for each measurand, and the measured values of the measurand(s) are determined on the basis of the values of the characteristic variables and in advance in a calibration method, the dependence of the values of the characteristic variable(s) of calibration data representing the values of the measurand(s) is determined. The calibration data required for this purpose is determined, for example, using reference measurements in which reference values of the characteristic variable(s) of reference pictures of the pattern 5 generated through the volume V of the predetermined shape of reference media with different, known values of the or each measurand are determined.

As can be seen from FIG. 9, for determining the measured values of the measurand turbidity T is used as a characteristic variable(s) dependent on this measurand, e.g., the image sharpness, the contrast and/or the size of the surface F of the images of the individual pattern elements contained in the pictures A. As illustrated with reference to FIGS. 10 and 11, the curvature and/or the line width of images of straight pattern elements, and/or the size of the surfaces of images of certain grid surfaces enclosed between lines, and/or the size of the surfaces of images of certain grid surfaces of the pattern 5 enclosed between lines, are used to determine the measured values of the measurand, for example the degree of distortion of the pictures A and/or at least one characteristic variable dependent on the degree of distortion, for example the degree of distortion of the pictures A and/or at least one characteristic variable dependent on the degree of distortion. For determining the measured values of the measurand absorption coefficient A, the brightness of the pictures A is used as the characteristic variable, for example.

Optionally, in conjunction with measurands, such as the turbidity T and the concentration Cp of particles contained in the medium 1, which in each case have the same effect on the individual images of the individual pattern elements contained in the pictures A, e.g., are moved in such a way that each characteristic variable used for determining the measured values of the corresponding measurand and dependent on the corresponding measurand is determined in each case on the basis of a plurality, an average value or a median of imaging characteristic variables of the individual images corresponding to the corresponding characteristic variable. In this procedure, the imaging characteristic variables form a plurality of simultaneously executed individual measurements, by means of which an improvement in the measurement accuracy is brought about in the determination of the characteristic variable in parallel.

This procedure can also be used analogously in the measurement of the absorption coefficient A, which likewise has the same effect on the individual images of the individual pattern elements contained in the pictures A. In this case, for example, the mean values or median of the brightness of the image points of the individual images are suitable as imaging characteristic variables. Alternatively, however, a mean value or median of the brightness of all image points of the pictures A can also be used here as a characteristic variable.

In principle, it suffices to measure a certain measurand that the measured values of this measurand are each determined on the basis of the values of the characteristic variable(s) dependent on the pictures A, which values are determined by the pictures A. Alternatively, analogously to the above statements regarding the alternatively usable pattern recognition methods, a dependence of the pictures A on the respective measurand and at least one further variable that can be determined using the pictures A, such as at least one further measurand to be measured and/or at least one property of the medium 1 that is different from the measurands to be measured and effects on the pictures A, can also be taken into account in the analytical or numerical determination of the measured values. In this way, the above-mentioned advantages of a multiparameter sensor and/or an increased measurement accuracy are also achieved in the analytical or numerical determination of the measured values.

For this purpose, the values of the characteristic variable(s) dependent on the corresponding measurand are also determined here on the basis of the pictures A. In addition, values of at least one characteristic variable of the pictures A dependent on the corresponding further variable are in each case determined for the or each further variable. In this embodiment, the measured values of the corresponding measurand are calculated on the basis of the values of the characteristic variable(s) dependent on the respective measurand and the values of the characteristic variable(s) dependent on each further variable, which values are dependent on the corresponding further variable, by means of a calculation rule which is determined in advance on the basis of calibration data. Analogous to the above statements, the calibration data used for this purpose is determined, for example, on the basis of reference measurements in which reference values of the characteristic variable(s) of pictures A of the pattern 5 generated by the volume V of the predetermined shape of reference media with different, known values of each measurand and each further variable are determined.

Irrespective of which of the previously described methods for determining the measured values is used, the measured values of the measurand(s) determined by means of the correspondingly designed evaluation device 7 are made available, for example, via an output device 35 of the sensor. For this purpose, an output device 35, which comprises an interface 37 via which the measured values, e.g., in the form of data or signals, can be read out, output, and/or can be transmitted to a higher-level unit, such as a goods, a process control, a control system, or a programmable logic controller, for example, is suitable for this purpose. Alternatively or additionally, the output device 35 comprises, for example, a Display 39 for displaying the measured values.

The present disclosure has the advantages mentioned above. Here, individual method steps of the method and/or individual components of the sensor can each have embodiments that can be used individually and/or in combination with one another.

For example, the pattern 5 can be positioned at different locations. FIGS. 1 and 6 show embodiments in which the pattern 5 is arranged outside the container 17a, 17b. Alternatively, however, the pattern 5 can also be attached to the container 17c. FIG. 8 shows an embodiment in which the pattern 5 is inserted into the container wall of the container 17c remote from the camera 3. In this variant, the pattern elements are arranged, for example, on an inner side, an outer side or in the interior of a transparent support inserted into the container wall, such as the window 27 shown in FIG. 8. This embodiment can also be used analogously in conjunction with other embodiment; e.g., by equipping the windows 23, 31, 33, shown in FIGS. 1, 7, 12, and 13, inserted into the container wall remote from the camera 3, or the cell walls facing away from the camera 3 with the pattern elements. In this case, the pattern elements can be arranged, for example, in one plane and/or can be applied to the planar outer side of the corresponding window 23, 31, 33, which is at the same time used as a pattern 5, pointing out of the container 17a, 17c.

Alternatively, the pattern elements of the pattern 5 can be arranged, for example, on an inner side pointing into the container of a transparent or non-transparent container wall facing away from the camera 3 or a non-transparent support used in this container wall. In this case, a lighting device 15 is preferably used, by means of which the front side of the pattern 5 facing the camera 3 can be illuminated.

A further embodiment consists in that the camera 3 and the evaluation device 7 are arranged at a spatial distance d, such as a distance d of greater than or equal to 10 cm, or of greater than or equal to 1 m, from the container 17a, 17b, 17b′, 17c. Depending on the size of the distance d, a camera 3 with telephoto lens is used, for example. In the case of sensors with lighting device 15, the lighting device 15 or at least each radiation source S is preferably also arranged at a spatial distance d, or a distance d of greater than or equal to 10 cm, from the container 17a, 17b, 17b′, 17c. This offers the advantage that the sensor can also be used in applications in which the medium 1 under certain circumstances has temperatures which are outside a temperature range in which the camera 3 and/or the evaluation device 7 can be used. In this respect, the sensor is designed, for example, as a two-part sensor whose passive components, such as the pattern 5 and the containers 17a, 17b, 17b′, 17c, from its electrical components, such as the camera 3 and the evaluation device 7, are arranged separated from one another by the distance d.

With regard to the evaluation of the pictures A, by means of the correspondingly designed evaluation device 7, it is, for example, moved in such a way that the pictures A are processed and the measured values are determined using the processed pictures A′.

A form of processing consists in generating pictures A′ prepared from multiple pictures A taken with different exposure times with a higher dynamic range. Methods known from photograph can be used for this purpose for generating photographs known in the art as “High Dynamic Range Images” (HDRI). This form of processing offers the advantage that larger contrasts can be processed thereby.

A further form of processing consists, for example, in the fact that image shifts of the images of the pattern 5 within the pictures A or the processed pictures A′ produced therefrom, such as, for example, by a misalignment, by shifting individual sensor components and/or image shifts caused by vibrations, are compensated for subsequently.

Alternatively or additionally thereto, it is, for example, moved in such a way that multiple pictures A taken in chronological succession or the processed pictures A′ produced therefrom are each combined into an overall image, and the measured values are determined in the manner described above using the overall images. An image stacking method and/or an image processing method, in which the image pixels of the overall image are determined as mean or median of the corresponding pixels of the pictures A or of the processed pictures A′, is used for generating the overall images, for example. The overall images offer the advantage that they have a better signal-to-noise ratio than the individual pictures A or the individual processed pictures A′. Correspondingly, determined measured values have a higher measurement accuracy on the basis of the overall images. A further advantage of the overall images is that the disadvantageous influence of faults which possibly occur briefly and which impair the measurement, such as bubbles occurring in the medium 1, is reduced to the measurement accuracy of the measured values.

In some embodiment variants, the sensor is equipped, for example, with a temperature sensor TE, such as the thermocouple arranged in or on the cuvette in FIG. 6, for measuring the temperature of the medium 1. In this case, the method and/or the evaluation device 7 is designed to determine the measured values of at least one measurand on the basis of the pictures A and the temperature of the medium 1 measured with the temperature sensor TE.

An alternatively or additionally usable embodiment is to design the method and/or the sensor in such a way that the measured values of the measurand or at least one of the measurands are each determined and made available at two or more different wavelengths. For this purpose, the lighting device 15 comprises two or more radiation sources S1, S2, S3 which can be switched on and off by means of a controller 41 and output electromagnetic radiation of different wavelengths. In this embodiment shown in FIG. 8 and which can also be used in the other exemplary embodiments, the evaluation device 7 is designed to determine the measured values for each of the wavelengths in the manner described above on the basis of those pictures A which have been taken during an illumination of or passing of light through the pattern 5 with the radiation of the corresponding wavelength emitted by one of the radiation sources S1, S2, S3 in each case. For example, colored light-emitting diodes, such as red, yellow, green or blue LEDs, which emit radiation with a wavelength corresponding to the corresponding color, in the visual spectrum, are suitable as radiation sources S1, S2, S3. Just as in the embodiments described above, the camera 3 is also designed here, for example, as a camera 3 detecting electromagnetic radiation in the visual region, such as, for example, as a black white camera or as a color camera.

Further optional embodiment of the method and/or of the sensor consists in that the lighting device 15 comprises a broadband radiation source Sw, such as an incandescent lamp, which is shown in dashed lines in FIG. 8 and can also be used analogously in the other embodiments, which is designed to output white light or light in a spectral range of 350 nm to 1200 nm. In this variant, the camera 3 is designed, for example, as a color camera and the evaluation device 7 is designed to determine the color of the medium 1 on the basis of the color of pictures A of the pattern 5 generated during an illumination of or passing of light through the pattern 5 with the white light and to provide a color measured value of the color and/or to detect and display a color change of the medium 1 on the basis of the color.

Alternatively or additionally, the lighting device 15 comprises, for example, a radiation source Suv shown in dashed lines in FIG. 8 and analogously also usable in the other embodiments, such as a UV LED, which is designed to output ultraviolet light, to one or more excitation wavelengths located outside of the visual spectrum. Ultraviolet light leads in the case of fluorescent media 1 to excitation of fluorescence in which fluorescent light with emission wavelengths located in the visual range is output by the medium 1. In this variant, too, the camera 3 is designed to detect electromagnetic radiation in the visual spectrum. This means that the camera 3 detects, if necessary, fluorescent light emitted by the medium 1 with the ultraviolet light when the pattern 5 is illuminated or has light passed through it. However, the ultraviolet light is not detected by the camera 3. Accordingly, the method and/or the evaluation device 7 in this variant is designed, for example, to determine whether or not the medium 1 is a fluorescent medium 1, and to make available corresponding information, on the basis of pictures A of the pattern 5 generated during an illumination of or passing of light through the pattern 5 with the ultraviolet light. Alternatively or additionally to this, on the basis of these pictures A, for example, an intensity of the fluorescent light and/or a property of the medium 1 corresponding thereto, such as a concentration of a fluorescent component contained in the medium 1, are determined by means of the evaluation device 7 and made available, for example, in the form of corresponding measured values, such as intensity measured values and/or concentration measured values.

Alternatively or additionally, the method and/or the evaluation device 7 is designed, for example, to identify images of particles and/or bubbles covering the pattern 5 in the pictures A, and to determine and provide measured values of at least one property of the particles and/or bubbles, such as, for example, their occurrence, their size, their number and/or their distribution.

Alternatively or additionally thereto, the method and/or the evaluation device 7 is designed, for example, to determine and provide measured values of a flow rate of the medium 1 to which the medium 1 flows through the container 17a, for example, on the basis of pictures A taken in chronological succession during a stroboscopic illumination of or passing of light through the pattern 5 carried out by means of the lighting device 15. Alternatively or additionally, for example, an alarm is output if the flow speed exceeds or falls below a prespecified limit value. The measurement of the flow rate is advantageous when the container 17a is designed as a flow cell, since a sufficiently high flow can be ensured here on the basis of the flow rate, and/or blockages of the flow cell that impede the flow can be detected. Corresponding advantages result analogously in conjunction with sensors designed as an immersion probe, the container 17b of which, formed as a recess, is passed through by the medium 1. The stroboscopic illumination of or passing of light through the pattern 5 is effected, for example, by a corresponding control, designed by means of the controller 41, of at least one radiation source S, S1, S2, S3, Sw of the lighting device 15, which radiation source emits radiation in the visual spectrum.

As explained above, the volume V of the medium 1 through which the pictures A are picked up by means of the camera 3 can have different shapes.

One embodiment provides that the volume V is shaped in such a way that a volume width b running parallel to the imaging path L running through the volume V varies continuously or continuously in a direction running perpendicular to the imaging path L, at least in portions. For this purpose, the volume V can have, for example, a cross-sectional area having the shape of a triangle, a trapezoid or a wedge at least in portions, and/or can be lens-shaped at least in portions. Exemplary embodiments for this are shown in FIGS. 7, 8, 12 and 13. In FIG. 8, the volume width b which runs in a direction perpendicular to the imaging path L and is shown in FIG. 8 in the direction pointing out of the container 17c is achieved in that one of the two planar windows 25 is inclined at an acute angle relative to the imaging path L and the other window 27 or the pattern 5 used instead of the window 27 is aligned perpendicular to the imaging path L. In FIG. 12, the continuous Variation of the volume width b is achieved by at least one of the windows 29, 31 in each case comprising the prism-shaped region P projecting into the container 17a. Alternatively, however, the volume V can also be limited at least on one side by a window which is stepped in cross section. In FIG. 7 and FIG. 13, the continuous variation of the volume width b is achieved by the lens shape of the volume V, which is brought about in FIG. 7 by the cell shape and in FIG. 13 by the domed windows 33.

The volume width b of the volume V that varies at least in portions causes the optical path length that the radiation absorbed by the camera 3 travels through the medium 1 to vary accordingly. In particular, in the measurement of measurands, such as the turbidity T and/or the absorption coefficient a, in which the radiation power received by the camera 3 is dependent on the value of the measurand, and with increasing optical path length extending through the medium 1, the advantage is achieved that the measurement region is thereby enlarged.

When using the previously described, learned and/or determined pattern recognition and/or classification methods trained on the basis of training data, this advantage occurs automatically and is also achievable analogously in the case of a corresponding numerical or analytical evaluation of the pictures A. In this respect, by means of the correspondingly designed evaluation device 7, for example exclusively or at least primarily those subregions of the pictures A are used for determining the measured values in which the received radiation power is large enough to enable the determination of the measured values, and the value of the measurand in an extent which can be quantitatively measured by means of the evaluation device 7 has an effect on the images of the pattern elements. The measured values are thus determined in the event of a strong turbidity of the medium 1 and/or a strongly absorbing medium 1, for example on the basis of partial regions of the pictures A, when the optical path running through the medium 1 is recorded accordingly. Similarly, the measured values are determined in a weak turbidity T of the medium 1 and/or an only weakly absorbing medium 1, e.g., on the basis of partial regions of the pictures A, during which the optical path running through the medium 1 is correspondingly long. The selection of corresponding partial regions can take place, for example, using radiation intensities received in individual picture regions from the camera 3. Optionally, the primary consideration of these partial regions, which takes place automatically in the use of pattern recognition and/or classification methods and/or of the previously described models for determining the measured values, can be amplified by corresponding specifications during their creation and/or use.

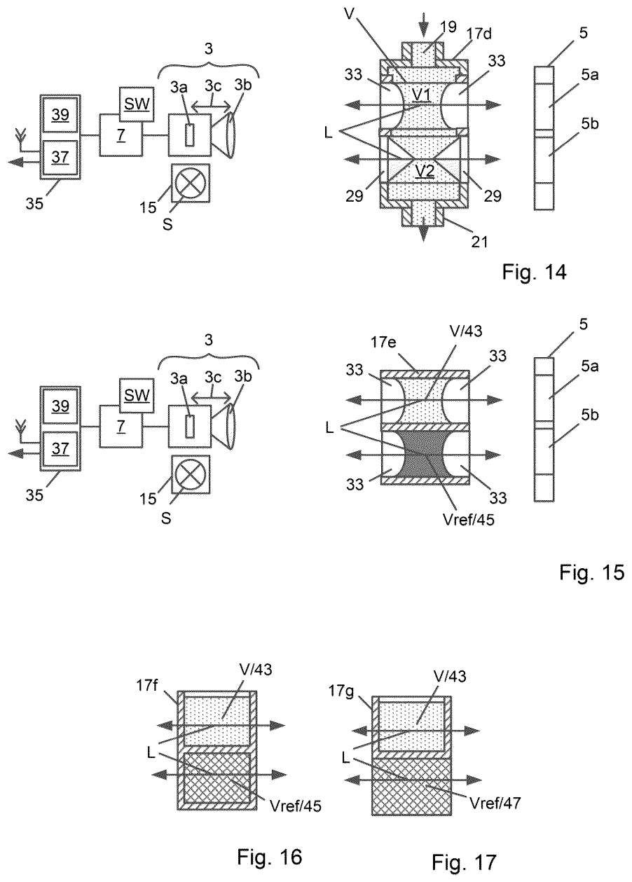

Alternatively or in addition to the above-mentioned embodiments, the volume V of the medium 1 is optionally designed, for example, in such a way that it has two or more volume regions V1, V2 of different shapes. An exemplary embodiment of this is shown in FIG. 14. In this case, the individual volume regions V1, V2 can each have one of the shapes previously described for the total volume. These volume regions V1, V2 are preferably arranged in such a way that a different pattern region 5a, 5b of the pattern 5 is respectively recorded through each volume region V1, V2. Correspondingly, the pictures A also each comprise a number of picture regions corresponding to the number of volume regions V1, V2, which in each case correspond to an image of the pattern 5a, 5b of the pattern 5, which image is recorded by means of the camera 3 through one of the volume regions V1, V2, in the viewing direction of the camera 3 behind the corresponding volume region V1, V2.

Analogous to the above-described volume shapes, a volume V having two or more volume regions V1, V2 of different shapes can also be brought about by a corresponding shape of the container and/or at least one window inserted into the container. FIG. 14 shows, for this purpose, an example of a container 17d in which the volume V of the medium 1 enclosed therein comprises a lens-shaped first volume region V1 and a second volume region V2 arranged between two, here, dome-shaped windows 33 used in the wall regions of the container 17d opposite one another along the imaging path L. The second volume region V2 is arranged between two windows 29 inserted into the wall regions of the container 17d that are opposite one another along the imaging path L, which windows each comprise a prism-shaped region P projecting into the container 17d. Alternatively, other combinations of two or more volume regions of different shapes can also be used.

Two or more volume regions V1, V2 offer the advantage that the measured values of the measurand(s) can each be determined or determined exclusively or at least primarily on the basis of those picture regions which, due to the shape of the volume region V1, V2 through which these picture regions have been taken, are well or most suitable. When using the previously described, learned or determined pattern recognition and/or classification methods, which are trained on the basis of training data, this evaluation method occurs automatically, and can optionally be amplified by corresponding specifications during their creation and/or use. Similarly, it can also be achieved by a corresponding numerical or analytical evaluation of the pictures A. In both cases, it is, for example, moved by means of the correspondingly designed evaluation device 7 in such a way that the measured values of the measurand or at least one of the measurands are determined on the basis of the pictures A of a first pattern region 5a contained in the pictures A and, on the basis of the images of at least one further pattern region 5b of the pattern 5 different from the first pattern region 5a, each measured values of at least one further variable, such as a further measurand and/or at least one characteristic of the medium 1 that is different from the measured values, are determined by means of the images of at least one further pattern region 5b of the pattern 5. In this case, the determination of the measured values of the measurand(s) and of each further variable carried out on the basis of the images of the individual pattern regions 5a, 5b contained in the pictures A takes place, for example, analogously to the determination of the measured values of the measurand(s) previously described based on the pictures A.

For example, in the example shown in FIG. 14, measured values of the refractive index n of the medium 1 can be determined on the basis of the images of the pattern region 5a taken through the lens-shaped volume region V1, and measured values of the turbidity T and/or of the absorption coefficient a of the medium 1 can be determined on the basis of the images of the other pattern region 5b taken through the other volume region V2.

Optionally, the measured values of at least one further variable can, for example, in each case be determined and made available as measured values of a measurand formed by the corresponding variable. Alternatively or additionally thereto, for example, a correction method is carried out in which the measured values of at least one measurand are respectively corrected on the basis of the measured values of at least one measurand different from the corresponding measurand and/or at least one further variable different from the measurands, such as a property of the medium 1. In this case, the evaluation device 7 is designed to determine the corrected measured values of the corresponding measurand and to provide them via the output device 35.

Another embodiment consists in that the sensor is designed in such a way that the pictures A taken with the camera 3 comprise a measurement picture region, taken through the volume V of the medium 1, of a pattern region 5a of the pattern 5 and at least one reference picture region, preferably identical, of a further, preferably identical pattern region 5b, which is taken through a reference volume Vref of a reference medium. For this purpose, the reference volume Vref of the reference medium is or is arranged, for example, in the viewing direction of the camera 3 next to the volume V of the medium 1, for example over, below, right or left of the volume V. A solid or a liquid having a known value of the or each measurand to be measured with the sensor is preferably used as reference medium. In this embodiment, the evaluation device 7 is designed, for example, to determine the measured values on the basis of the measurement picture regions and the reference picture regions of the pictures A. For this purpose, the previously described methods for determining the measured values can be used, wherein the measurement picture regions of the pictures A are used as pictures A of the pattern 5 and the reference picture regions are used as reference pictures. This embodiment offers the advantage that the effort required to generate reference pictures can be considerably reduced.

The reference volume Vref of the reference medium can be provided in different ways. FIG. 15 shows an embodiment of a sensor designed as described above, the container 17e of which comprises a first interior 43 for receiving the volume V of the predetermined shape of the medium 1 and a second interior 45 which is adjacent thereto and is separated from the first interior 43 for receiving the reference volume Vref of the reference medium. The container 17e is also designed here, for example, as a flow measuring cell which is shown in FIG. 15 for illustration in a sectional plane which is shown perpendicular to a longitudinal axis of the diameter cell connecting the inlet 19 to the outlet 21. Preferably, the reference volume Vref also has the shape specified for the volume V of the medium 1. In the example shown in FIG. 15, both the volume V and the reference volume Vref have the shape of a bi-concave lens which is achieved in that the volume V and the reference volume Vref are each arranged between two correspondingly shaped windows 33 inserted into the container 17e. Irrespective of the volume shape, the second interior 45 is optionally designed, for example, as a closed interior or connected to at least one connection via which the reference medium can be exchanged if required.

FIG. 16 and FIG. 17 each show an example of a container 17f, 17g usable instead of the container 17e shown in FIG. 15. The container 17f shown in FIG. 16 is designed as a cuvette, the second interior 45 of which is designed as a closed interior filled with the reference medium. The container 17g shown in FIG. 17 comprises a cuvette which has the first interior 43 fillable or filled with the medium 1 and is arranged on a base 47 which consists of the reference medium which is designed here as a solid and has the reference volume Vref.

1. A method for measuring one or at least two measurands of a transparent medium, in which
pictures of a pattern are taken through a volume of predetermined shape of the medium using a camera, and
measured values of the measurand(s) are determined and made available on the basis of effects of the volume of the medium on the pictures of the pattern, said effects being characteristic of the measurand(s) and dependent on the value thereof.

2. The method according to claim 1, in which
the effects characteristic of the measurand(s) are quantitatively detected by means of the pictures and at least one reference picture of the pattern taken in each case through a volume of the predetermined shape of a reference medium having a known value of each measurand, and assigned to the associated measured value of the respective measurand, wherein the reference picture(s) comprise at least one experimentally generated and/or at least one reference picture produced numerically by simulation calculations; and/or
the measured values are determined on the basis of the pictures by means of a pattern recognition and/or classification method or a pattern recognition and/or classification method trained, learned or ascertained on the basis of training data, and/or
at least one model for determining measured values of the measurand(s) is created in advance on the basis of training data, with the aid of which measured values are then determined, wherein:
the measured values of the at least one of the or each measurand are determined in each case on the basis of the model or one of the models, in such a way that the dependence of the pictures reflects the respective measurand, and/or
the measured values of the at least one of the or each measurand are determined in each case on the basis of the model or one of the models, in such a way that it takes into account the dependence of the pictures from the respective measurand and at least one further variable determinable by means of the pictures, wherein the at least one further variable comprises at least one further measurand, the measured values of which are determined and made available, and/or comprises at least one property of the medium that is different from each measurand to be measured and has an effect on the pictures.

3. The method according to claim 1, in which:
the measured values are determined by means of an analytical or numerical evaluation of the pictures, and/or
values of at least one characteristic variable of the pictures dependent on the respective measurand are determined on the basis of the pictures for each measurand, and the measured values of the measurand(s) are determined on the basis of the values of the characteristic variables and in advance in a calibration method, the dependence of the values of the characteristic variable(s) on calibration data representing the values of the measurand(s) is determined, wherein:
for determining the measured values of at least one measurand which has an effect on the individual images of individual pattern elements of the pattern contained in the pictures, an approach is adopted such that each characteristic variable used for determining the measured values of the respective measurand is determined in each case on the basis of a plurality, an average value or a median of imaging characteristic variables of the individual images corresponding to the respective characteristic variable,
the measured values of each measurand are determined in each case on the basis of the values, determined on the basis of the pictures, of the characteristic variable(s) dependent on the respective measurand, and/or
the measured values of the, at least one of the or each measurand are determined in each case in that:
the values of the characteristic variable(s) dependent on the respective measurand are determined on the basis of the pictures,
for at least one further variable that can be determined by means of the pictures, values of at least one characteristic variable of the pictures that is dependent on the corresponding further variable are determined, wherein the at least one further variable comprises at least one measurand different from the corresponding measurand and/or at least one property of the medium different from each measurand, and
the measured values of the respective measurand are calculated on the basis of the values of the characteristic variable(s) dependent on the respective measurand and the values, determined for each further variable, of the characteristic variable(s) dependent on the respective further variable by means of a calculation rule determined in advance on the basis of calibration data.

4. The method according to claim 1, in which:
the pictures are processed and the measured values are determined on the basis of the processed pictures and/or the pictures are processed in such a way that:
image shifts of the images of the pattern within the pictures by shifting individual sensor components of a sensor that comprises the camera and the pattern for generating the pictures and/or image shifts caused by vibrations, are subsequently compensated for, and/or
pictures with a higher dynamic range that have been processed from multiple pictures taken with different exposure times are produced, and/or
multiple pictures taken in chronological succession or the processed pictures produced therefrom are each combined into an overall image and the measured values are determined using the overall images.

5. The method according to claim 1, in which:
the volume is shaped in such a way that a volume width running parallel to the imaging path running through the volume varies at least in portions continuously or in steps in a direction perpendicular to the imaging path, and
the measured values of the, at least one or each measurand are determined in each case on the basis of the pictures and/or are determined exclusively or at least primarily on the basis of those partial regions of the pictures in which the received radiation power is large enough to enable the determination of the measured values, and the value of the measurand has an effect on the pictures of the pattern elements to an extent that can be quantitatively measured by means of the evaluation device.

6. The method according to claim 1, in which:
the volume has two or more volume regions of different shape,
the individual volume regions are arranged in such a way that a different pattern region of the pattern is taken by the camera through each volume region, and the pictures each comprise a number of picture regions corresponding to the number of volume regions, which in each case correspond to an image, taken with the camera through one of the volume regions, of the pattern region of the pattern arranged downstream of the respective volume region in the viewing direction of the camera, and
the measured values of the, at least one or each measurand in each case:
are determined on the basis of the pictures and/or are determined exclusively or at least primarily on the basis of those picture regions which are suitable, well suited or best suited for this purpose due to the shape of the volume region through which these picture regions have been taken, and/or
are determined in that:
the measured values of at least one measurand are determined on the basis of the images of a first pattern region of the pattern contained in the pictures,
measured values of at least one further variable that can be determined using the pictures are determined in each case on the basis of the images contained in the pictures of at least one further pattern region of the pattern that is different from the first pattern region, and
an approach is adopted such that:
the measured values are made available to at least one further variable designed as one of the measurand(s), and/or
a correction method is carried out in which the measured values of at least one measurand are each corrected on the basis of the measured values of at least one measurand different from the respective measurand and/or at least one further variable different from each measurand and the corrected measured values of the corresponding measurand are made available.

7. The method according to claim 1, in which:
the measurand(s) comprise a turbidity of the medium, a concentration of particles contained in the medium, and/or an absorption coefficient of the medium,
the measurand(s) comprise a refractive index of the medium, and/or a concentration of a substance contained in the medium and at least jointly responsible for the refractive index of the medium, wherein the volume used in the measurement of this (these) measurand(s) in the imaging path has an outer surface through which the imaging path runs and which is designed at least in portions such that radiation entering the volume of the medium and/or exiting from the volume through the respective outer surface is refracted in a manner dependent on the refractive index,
measured values of at least one measurand designed as a secondary measurand are determined, the changes of which result in corresponding changes of at least one measurand measurable on the basis of the pictures, and/or
measured values of at least one measurand are determined on the basis of the pictures of the pattern that are taken through the volume of the medium and a temperature of the medium measured using a temperature sensor.

8. The method according to claim 7, in which:
measured values of the turbidity and/or the concentration of the particles contained in the medium are determined on the basis of an image sharpness and/or a contrast of the pictures and/or of the images of the individual pattern elements of the pattern contained in the pictures, and/or on the basis of the size of the areas over which the images of the individual pattern elements of the pattern extend within the pictures,
measured values of the refractive index and/or of the concentration of the substance are determined on the basis of a degree of a distortion of the pictures caused by the refractive index and the predetermined shape of the volume and/or at least one characteristic variable of the pictures changing depending on the degree of distortion, and/or
measured values of the absorption are determined on the basis of a brightness of the image points of the pictures of the pattern.

9. A sensor for measuring one or at least two measurands of a transparent medium, having
a pattern,
a camera for generating pictures of the pattern, wherein the camera and the pattern are arranged in such a way and the sensor is designed in such a way that an imaging path running from the pattern to the camera runs through a volume of predetermined shape of the medium inserted or insertable into the imaging path, and
an evaluation device, which is connected to the camera and which is designed to determine and make available measured values of the measurand(s) on the basis of effects of the volume of the medium on the pictures of the pattern, said effects being characteristic of the measurand(s) and dependent on the value thereof.

10. The sensor according to claim 9, in which:
the measurand(s) comprise a turbidity of the medium, a concentration of particles contained in the medium, and/or an absorption coefficient of the medium,
the measurand(s) comprise a refractive index of the medium, and/or a concentration of a substance contained in the medium and at least jointly responsible for the refractive index of the medium, wherein the volume used in the imaging path has at least one outer surface through which the imaging path runs and which is designed at least in portions such that radiation entering the volume of the medium and/or exiting from the volume through the respective outer surface is refracted in a manner dependent on the refractive index, and/or
the evaluation device is designed to determine measured values of at least one measurand designed as a secondary measurand, the changes of which result in corresponding changes at least of one measurand measurable on the basis of the pictures, and/or
the sensor comprises a temperature sensor for measuring the temperature of the medium, and the evaluation device is designed to determine measured values of at least one measurand on the basis of the pictures and a temperature of the medium measured with the temperature sensor.

11. The sensor according to claim 9, having a container which is transparent at least in portions and/or equipped with at least one transparent window, a container designed as a cuvette or as a disposable cuvette, or a container formed by a recess of the sensor open toward the surroundings, for receiving the medium, wherein the container has an interior which has the shape predetermined for the volume of the medium.

12. The sensor according to claim 11, in which a transparent window, a window designed as a planar pane, a window having the shape of a hollow-cylinder segment, a window having a prism-shaped region projecting into the container, a domed window, or a window having a window surface facing the interior of the container and curved into the container or out of the container, is inserted into a first container wall of the container facing the camera or into the first container wall and into a second container wall of the container facing away from the camera and opposite the first container wall along the imaging path, and the imaging path runs through said window.

13. The sensor according to claim 12, in which:
one of the two windows is designed as a pane inclined with respect to the imaging path, and the other window is designed as a pane aligned perpendicular to the imaging path,
one of the two windows has a prism-shaped region projecting into the container, and the other window is designed as a pane or has a prism-shaped region protruding into the container, or
both windows are domed, both windows have a window surface which is curved into the container, or both windows have a window surface which faces the interior of the container and is curved out of the container.

14. The sensor according to claim 9, in which the volume having the predetermined shape, overall or at least in portions:
is designed as a cuboid or as a cube, is designed as a cylinder, which has the shape of a lens, a bi-convex lens, a plano-convex lens, a concave-convex lens, a convex-concave lens, a plano-concave lens or a bi-concave lens,
is shaped in such a way that a volume width running parallel to the imaging path running through the volume varies at least in portions continuously or in steps in a direction perpendicular to the imaging path, and/or
has two or more volume regions of different shape, wherein the individual volume regions are arranged in such a way that a different pattern region of the pattern is recorded by the camera through each volume region.

15. The sensor according to claim 9, comprising a lighting device for illuminating the pattern, which lighting device is designed to illuminate a front side of the pattern facing the camera and/or to pass light through the pattern from its rear side remote from the camera.

16. The sensor according to claim 15, in which:
the lighting device comprises two or more radiation sources which can be switched on and off by means of a controller, or radiation sources designed as light-emitting diodes, which emit electromagnetic radiation of different wavelengths, and the evaluation device is designed to determine and make available the measured values of the measurand or at least one of the measurands in each case at two or more different wavelengths, wherein the evaluation device determines the measured values for each of the wavelengths in each case on the basis of those pictures which were taken during an illumination of or passing of light through the pattern with the radiation emitted by one of the radiation sources of the respective wavelength,
the lighting device comprises a broadband radiation source or a radiation source designed as an incandescent lamp, which is designed to output white light or light in a spectral range of 350 nm to 1200 nm, the camera is designed as a color camera, and the evaluation device is designed to determine the color of the medium on the basis of the color of pictures of the pattern generated during an illumination of or passing of light through the pattern with the white light and to make available a color measured value of the color and/or to detect and display color changes of the medium on the basis of the color,
the lighting device comprises a radiation source or a radiation source designed as a UV-LED, which radiation source is designed to output ultraviolet light with one or more excitation wavelengths located outside of the visual spectrum, the camera is designed to detect electromagnetic radiation in the visual spectrum, and the evaluation device is designed, on the basis of pictures of the pattern generated during an illumination of or passing of light through the pattern with the ultraviolet light:
to determine whether or not the medium is a fluorescent medium and to make available corresponding information,
to determine and make available intensity measured values of an intensity of a fluorescent light emitted by the medium, and/or
to determine and make available concentration measured values of a concentration of a fluorescent component contained in the medium, and/or
the evaluation device is designed, on the basis of pictures of the pattern which are taken in chronological succession during a stroboscope illumination of or passing of light through the pattern carried out by means of the lighting device, to determine and make available measured values of a flow speed of the medium with which the medium flows through the container, and/or to output an alarm, and/or to output an alarm if the flow speed exceeds or falls below a predetermined limit value,
the lighting device comprises at least one radiation source designed as a broadband light source if the camera is designed as a color camera, as a camera with a color image sensor or as a WebCam, and the lighting device comprises at least one electromagnetic radiation of a radiation source emitting one or more wavelengths, when the camera is designed as a black-and-white camera or as a camera with a monochromatic image sensor, and/or
the lighting device comprises two or more radiation sources, wherein the radiation sources comprise radiation sources arranged in a group, in an array and/or in an illumination ring.

17. The sensor according to claim 9, in which the evaluation device is designed to identify images, contained in the pictures, of particles and/or bubbles which are contained in the medium and conceal the pattern, and to determine and make available measured values of at least one property of the particles and/or bubbles.

18. The sensor according to claim 9, in which:
the pattern:
has identical pattern elements arranged in a grid or randomly arranged and/or distributed in a planar plane, and/or is designed as a dot pattern, as a line pattern, as a grating, or as a hole pattern, and/or
is designed as a fixedly installed component or as an exchangeable component of the sensor, and/or
the pattern:
comprises printed-on, glued-on or applied pattern elements arranged on a support, on an inner side of a container wall of the container facing the camera or on or in a window inserted into the container, or
comprises a support designed as an opaque plate, on the side of which, facing the camera, there is arranged at least one pattern element printed on, glued on or applied, and/or through which there runs at least one recess, which forms one of the pattern elements, or
is designed as an electronically predeterminable pattern, wherein the pattern comprises a liquid crystal display for displaying the pattern elements or electronically controllable screens, or
comprises a transparent support, on the rear side of which, facing away from the camera, first ends of light guides are fastened, the second ends of which are connected to a light source, wherein the pattern elements comprise light spots generated by light fed by means of the light source into the light guides, or
comprises a support with bores running through the support, wherein a first end of at least one light guide is inserted into the bores, wherein the second ends of the light guide are connected to a light source, and the pattern elements comprise light spots generated by light fed by means of the light source (Q) into the light guide (LF), wherein the light guides (LF) have a light-conducting core having a diameter of a few micrometers and an outer diameter of greater than or equal to 100 μm or greater than or equal to 200 μm.

19. The sensor according to claim 9, in which:
the camera comprises an image sensor, an optical system upstream of the image sensor, and/or a focusing device,
the lighting device is arranged in the vicinity of the camera, and radiation emanating from the lighting device is arranged via a deflection device onto which the rear side of the pattern remote from the camera is directed,
a diffuser is arranged between the lighting device and the pattern,
a collimator is arranged between the lighting device and the volume of the medium, and/or
the camera and the evaluation device are arranged at a distance of greater than or equal to 10 cm or greater than or equal to 1 m from the volume of the medium.

20. The sensor according to claim 9, comprising:
a reference volume of a reference medium designed as part of the sensor or introducible into the sensor,
wherein the reference volume is arranged in the sensor in such a way that the pictures taken with the camera comprise a measurement picture region, which is recorded through the volume of the medium, of a pattern region of the pattern and a reference picture region, which is recorded through the reference volume of the reference medium, of a further pattern region of the pattern.

21. The sensor according to claim 20, in which:
the reference volume of the reference medium is arranged next to the volume of the medium in the viewing direction of the camera,
the reference medium is a solid or a liquid having a known value of the or each measurand,
the reference volume has the shape predetermined for the volume, and/or
the container of the sensor:
comprises a first interior for receiving the volume of the predetermined shape of the medium and a second interior adjacent thereto, which is separated from the first interior and is filled or can be filled with the reference volume of the reference medium, or
comprises a cuvette which has a first interior fillable or filled with the medium and is arranged on a base made of the reference medium which is designed as a solid and has the reference volume.
